(19) United States
(12) Patent Application Publication
(10) Pub. No.: US 2019/0047431 A1
(43) Pub. Date: Feb. 14, 2019

(54) ELECTRIC VEHICLE AND POWER TRANSMISSION SYSTEM FOR TRANSMITTING ELECTRIC POWER TO THE ELECTRIC VEHICLE

(71) Applicant: HONDA MOTOR CO., LTD., Tokyo (JP)

(72) Inventors: Hideaki Iwashita, Wako-shi (JP); Mitsuhiro Araki, Wako-shi (JP)

(21) Appl. No.: 16/056,575

(22) Filed: Aug. 7, 2018

(30) Foreign Application Priority Data
Aug. 10, 2017 (JP) 2017-155718

(51) Int. Cl. B60L 11/18; H02J 7/02; H02J 50/10

(52) U.S. Cl. CPC B60L 11/1838; B60L 11/182; H02J 50/10; H02J 7/025

(57) ABSTRACT

An electric vehicle itself has a contactor for shutting off reception of electric power from a road side. The reception of electric power is promptly stopped upon receiving a power reception disabling instruction from a power management server.

### CROSS-REFERENCE TO RELATED APPLICATION

This application is based upon and claims the benefit of priority from Japanese Patent Application No. 2017-155718 filed on Aug. 10, 2017, the contents of which are incorporated herein by reference.

### BACKGROUND OF THE INVENTION

### Field of the Invention

The present invention relates to an electric vehicle that is capable of traveling on a road while receiving electric power transmitted from the side of the road, and a power transmission system for transmitting electric power to the electric vehicle.

### Description of the Related Art

A power transmission system of this kind is disclosed in Japanese Laid-Open Patent Publication No. 2017-027634 (hereinafter referred to as JPA2017-027634), for example.

A non-contact power transmission device disclosed in JPA2017-027634 supplies charging electric power in a non-contact manner to an electric vehicle traveling on a toll road ([0013] of JPA2017-027634).

In this non-contact charging system, a charging server which manages feeding of electric power to traveling electric vehicles performs an authentication process as to whether to permit charging or not for electric vehicles traveling on the toll road, and thereby makes it possible to selectively supply electric power to those electric vehicles for which charging has been permitted based on the result of authentication ([0011] and [0013] of JPA2017-027634).

### SUMMARY OF THE INVENTION

However, since the technique described in JPA2017-027634 determines whether it is appropriate to supply electric power or not based on the result of authentication process performed while a vehicle is traveling on a toll road, the vehicle cannot receive electric power from the road within an area corresponding to a distance by which the vehicle travels until the result of determination is obtained, which leads to power transmission loss. Particularly in a case where a charging available road is a short section, sufficient reception (charging) of electric power is not completed.

A possible way to prevent occurrence of such power transmission loss is to employ a system in which it is possible for the vehicle to automatically receive electric power without going through an authentication process. In that case, however, even users who have not paid for electricity or the like are also allowed to receive electric power, thereby potentially bringing detriment to users who have paid for electricity or the like.

The present invention has been made in view of this problem, and an object thereof is to provide an electric vehicle and a power transmission system for transmitting electric power to the electric vehicle, in which no detriment is brought to users or the like while suppressing occurrence of power transmission loss.

According to an aspect of the present invention, there is provided an electric vehicle configured to receive, during traveling, electric power transmitted from a road-side facility provided on a side of a road and managed by a power management entity. The electric vehicle includes: a receiver configured to receive an instruction from the power management entity; a shutoff unit configured to shut off reception of the electric power transmitted from the road-side facility; and a controller connected to the receiver and the shutoff unit. The controller controls the shutoff unit when a power reception disabling instruction for the electric vehicle is received from the power management entity through the receiver.

According to the present invention, since the electric vehicle itself has the shutoff unit for shutting off the reception of electric power from the side of the road, the reception of electric power can be promptly stopped upon receiving a power reception disabling instruction from the power management entity. Thus, an electric vehicle associated with a user who has not yet paid for electricity, for example, is inhibited from receiving electric power, thereby preventing occurrence of detriment to users who have paid for electricity.

In this case, the electric vehicle may further include a notification unit, and when reception of the electric power by the electric vehicle is shut off, the controller may notify an occupant of the electric vehicle of the shutoff through the notification unit.

According to the present invention, it is possible to alert an occupant who mistakenly assumes that his/her vehicle is allowed to receive electric power on a power available road.

According to another aspect of the present invention, there is also provided a power transmission system configured to transmit electric power to an electric vehicle from a road-side facility and including a road-side communication device. When a power transmission disabling instruction to disable transmission of electric power to a particular electric vehicle is sent from a power management entity, the road-side facility communicates with the electric vehicle via the road-side communication device, and if the electric vehicle is identified as the particular electric vehicle, the road-side facility stops transmission of electric power to the electric vehicle.

According to the present invention, the power transmission system stops transmission of electric power to the electric vehicle upon receiving a power transmission disabling instruction from the power management entity. Thus, occurrence of wasted electric power in the power transmission system can be completely eliminated.

According to the present invention, the electric vehicle itself shuts off the reception of electric power from the side of the road upon receiving a power reception disabling instruction from the power management entity, so that the reception of electric power is promptly stopped. Thus, an electric vehicle associated with a user who has not paid for electricity, for example, is inhibited from receiving electric power, thereby preventing occurrence of detriment to users who have paid for electricity or the like.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a diagram schematically showing a configuration of a power transmission system for transmitting electric power to an electric vehicle according to an embodiment of the present invention;

FIG. 2 is a diagram illustrating in more detail configurations of the electric vehicle and a road-side facility of the power transmission system;

FIG. 3 is a flowchart of a program executed by a supervising unit of a secondary-side control device of the electric vehicle;

FIG. 4 is a diagram schematically showing a configuration of a power transmission system for an electric vehicle according to first and second modifications of the embodiment;

FIG. 5 is a diagram illustrating in more detail configurations of the electric vehicle and the road-side facility of the power transmission system according to the first modification;

FIG. 6 is a flowchart for describing the operation of the first modification;

FIG. 7 is a diagram illustrating in more detail configurations of the electric vehicle and the road-side facility of the power transmission system according to the second modification;

FIG. 8 is a flowchart for describing the operation of the second modification; and

FIG. 9 is a diagram schematically showing a configuration of a power transmission system for an electric vehicle according to a third modification.

### DESCRIPTION OF THE PREFERRED EMBODIMENTS

An electric vehicle and a power transmission system for transmitting electric power to the electric vehicle according to the present invention will be now described in detail by illustrating a preferred embodiment with reference to the accompanying drawings.

Although the embodiment is described for a system that transmits electric power in a non-contact manner, the present invention is also applicable to a system that transmits electric power in a contact manner.

### Embodiment

### [Configuration of Embodiment]

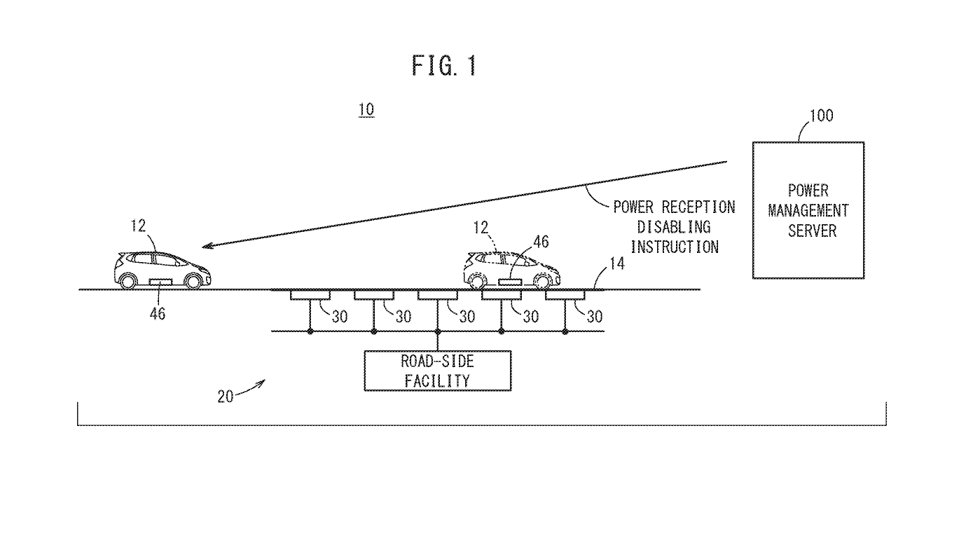

FIG. 1 is a diagram schematically showing the configuration of a power transmission system 10 for transmitting electric power to an electric vehicle 12 according to the embodiment.

The power transmission system 10 is composed of a primary-side (power transmitting side, power feeding side) road-side facility 20 provided on the side of a road 14, and a power management server 100 as a power management entity managed by an electric power company. The road-side facility 20 transmits electric power to the electric vehicle 12, which is a secondary-side (power receiving side), from the side of the road 14.

The power management server 100 manages and stores the right of use (user authority) of the road-side facility 20 for each user of a registered electric vehicle 12; the power management server 100 has the function of, for example, in a case that an electric vehicle 12 is under management of a user that has not yet paid a usage fee, disabling the reception of electric power by the electric vehicle 12.

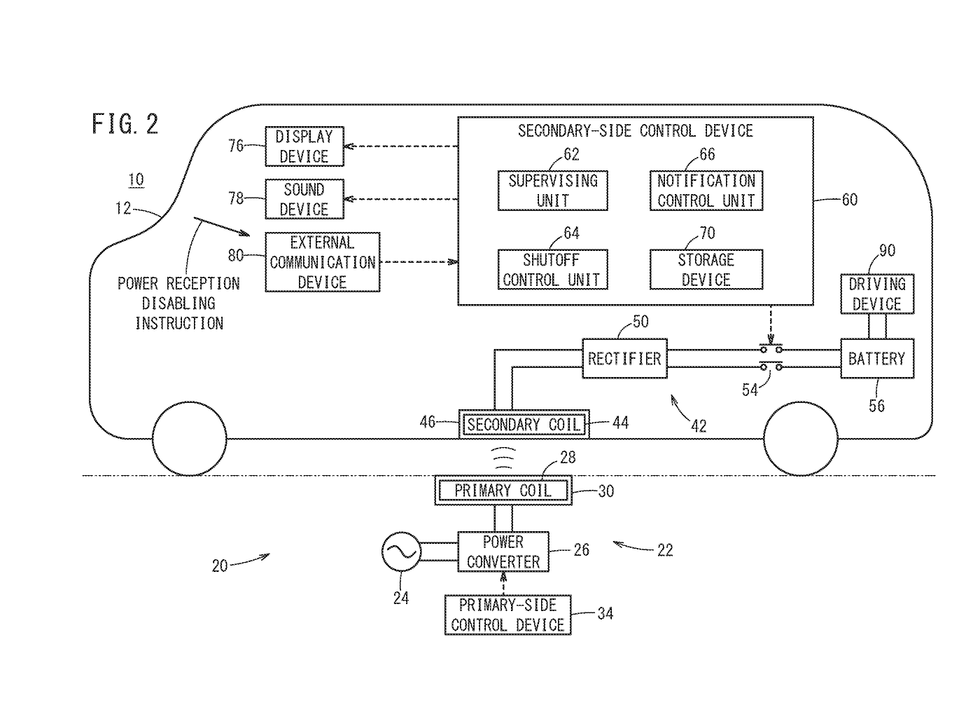

FIG. 2 is a diagram illustrating in more detail configurations of the electric vehicle 12 and the road-side facility 20 of the power transmission system 10.

A battery 56 contained in the electric vehicle 12 is charged by the road-side facility 20 in a non-contact manner during traveling, for example.

The road-side facility 20 mainly includes a power transmitting circuit 22 and a primary-side control device 34. The power transmitting circuit 22 includes an AC (alternating-current) source 24, a power converter 26 for converting AC power supplied from the AC source 24 into transmission electric power, and a primary coil 28. The primary coil 28 is covered with a primary pad 30 and buried in the road 14.

The primary-side control device 34 functions as predetermined functional units via reading and execution of programs stored in a storage device (not shown) by a processor (not shown) such as a CPU.

Meanwhile, the electric vehicle 12 mainly includes a power receiving circuit 42, the battery 56, a secondary-side control device 60, a display device 76, a sound device 78, an external communication device 80, and a driving device 90.

The power receiving circuit 42 includes a secondary coil 44, a rectifier 50 for rectifying received electric power, which is AC power received by the secondary coil 44, and a contactor 54 that switches between electrical connection and electrical disconnection between the power receiving circuit 42 and the battery 56. The secondary coil 44 is covered with a secondary pad 46 and disposed on a lower surface of the electric vehicle 12.

The battery 56, which may be a lithium ion battery for example, is charged via the power receiving circuit 42 when the contactor 54 is placed into a connected state and the secondary coil 44 is magnetically coupled to the primary coil 28, which is generating transmission electric power.

The secondary-side control device 60 is an ECU, and manages a power receiving process. The secondary-side control device 60 functions as a supervising unit 62, a shutoff control unit 64, and a notification control unit 66 via reading and execution of programs stored in a storage device 70 by a processor (not shown) such as a CPU.

The supervising unit 62 centrally manages the power receiving process.

The shutoff control unit 64 controls switching between ON and OFF of the contactor 54.

The notification control unit 66 causes the display device 76 and the sound device 78 to give notice of, for example, a reason why the contactor 54 has been switched from an ON state to an OFF state when an occupant (user) of the electric vehicle 12 charges the electric vehicle 12 at the location of the road-side facility 20 during traveling of the electric vehicle 12.

The storage device 70 stores therein various programs and predetermined or predefined values for use in various kinds of calculation, the right of use of the road-side facility 20 for each user of the electric vehicle 12, etc.

The external communication device 80 is connected with the secondary-side control device 60 over a communication line. The external communication device 80 wirelessly receives instructions from the power management server 100.

The driving device 90 includes a driving force device which generates driving force in response to an operation of an acceleration pedal performed by the occupant, as well as a steering device which effects steering in response to an operation of a steering wheel performed by the occupant, and a braking device which generates braking force in response to an operation of a brake pedal performed by the occupant. The driving force device includes an electric motor as a driving source, which is supplied with electric power from the battery 56.

### [Operation of Embodiment]

The power management server 100 previously registers and stores therein electric vehicles 12 that are under management of users who have not yet paid the usage fee for the road-side facility 20 and electric vehicles 12 that are under management of users who have properly paid the usage fee, in cooperation with financial institutions such as banks.

In addition to registering and storing the electric vehicle 12 itself in the power management server 100, an Electronic Toll Collection (ETC (a registered trademark)) card or a similar IC card for insertion into in-vehicle equipment provided on the electric vehicle 12, for example, may be registered and stored in the power management server 100. In the case of using an IC card, authentication is conducted between road-side equipment provided in the road-side facility 20 and the IC card inserted in the in-vehicle equipment over wireless communication when the electric vehicle 12 utilizes the road-side facility 20.

In the case of using an IC card, the power management server 100 and the IC card may wirelessly communicate directly with each other over a mobile communication network or the like. Alternatively, the contents (information) in the IC card may be read and written by the in-vehicle equipment, and the in-vehicle equipment may perform wireless communication with the power management server 100 over a mobile communication network and the like. Alternatively, with another technique, communication may be performed between the IC card and the power management server 100 to thereby conduct authentication therebetween. The above also applies to the first to third modifications to be described later.

The power management server 100 transmits a “power reception disabling instruction” to an electric vehicle 12 that has no right of use due to an unpaid usage fee or the like, among the registered electric vehicles 12 (see FIG. 1).

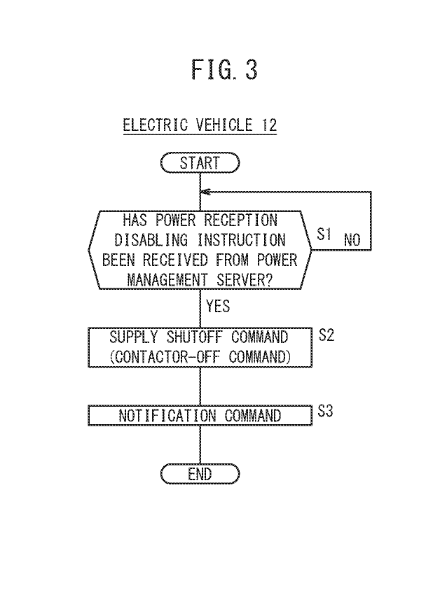

FIG. 3 shows a flowchart of a program executed by the supervising unit 62 of the secondary-side control device 60 of the electric vehicle 12.

At step S1, the electric vehicle 12 determines whether a “power reception disabling instruction” has been received from the power management server 100 through the external communication device 80 or not. If a “power reception disabling instruction” has been received (step S1: YES), the external communication device 80 sends the received “power reception disabling instruction” to the supervising unit 62 of the secondary-side control device 60.

At step S2, the supervising unit 62 of the secondary-side control device 60 analyzes the “power reception disabling instruction” and supplies a shutoff command to the shutoff control unit 64 for execution of the instruction. Based on the shutoff command, the shutoff control unit 64 switches the contactor 54 from an ON state (closed state) to an OFF state (open state).

As shown in FIG. 1, when the electric vehicle 12 travels from the left-hand side toward the road-side facility 20 in the drawing, since the contactor 54 of the electric vehicle 12 has been switched to an OFF state, the battery 56 is not charged even if the electric vehicle 12 travels on the road 14 in which the primary pad 30 is buried and electric power is being transmitted from the primary pad 30.

Upon analyzing the “power reception disabling instruction” from the power management server 100, the supervising unit 62 sends a shutoff command to the shutoff control unit 64 at step S2 and, at step S3, supplies a notification command to the notification control unit 66 for controlling the notification control unit 66 to cause the display device 76 to display an indication that “reception of electric power is not available because the user has not yet paid the fee”, and also to cause the sound device 78 to inform the user of the fact by voice.

### [Summation of Embodiment]

As described with reference to FIGS. 1 to 3, with the electric vehicle 12 according to the above embodiment, if the electric vehicle 12 is under management of a user who has properly paid a usage fee for electricity or the like, the electric vehicle 12 receives electric power transmitted from the road-side facility 20 provided on the side of the road 14 and which is managed by the power management server 100 as a power management entity, while the electric vehicle 12 is traveling on the road 14.

The electric vehicle 12 includes the external communication device 80 serving as a receiver for receiving a power reception disabling instruction from the power management server 100, the contactor 54 serving as a shutoff unit for shutting off reception of the electric power transmitted from the road-side facility 20, and the secondary-side control device 60 serving as a controller connected with the external communication device 80 and the contactor 54.

In this case, when a “power reception disabling instruction” for the electric vehicle 12 is received from the power management server 100 through the external communication device 80, the secondary-side control device 60 controls the contactor 54 to be in a shut-off state, namely an OFF state (open state), in order to disable the reception of electric power by the electric vehicle 12 from the road-side facility 20.

In this manner, since in this embodiment the electric vehicle 12 itself has the contactor 54 serving as a shutoff unit for shutting off the reception of electric power from the side of the road 14, the reception of electric power is promptly stopped upon receiving a “power reception disabling instruction” from the power management server 100. As a result, non-contact charging of the battery 56 in the electric vehicle 12 from the road-side facility 20 is prohibited or disabled. Thus, an electric vehicle 12 associated with a user who has not yet paid for electricity, for example, is inhibited from receiving electric power, thereby preventing occurrence of detriment to users who have paid for electricity.

Moreover, when the contactor 54 has been placed in an OFF state, in other words, when the reception of electric power by the electric vehicle 12 is interrupted by the power management server 100, the secondary-side control device 60 of the electric vehicle 12 notifies the occupant of the electric vehicle 12 that the reception of electric power by the electric vehicle 12 has been disabled, through at least one of the display device 76 and the sound device 78 serving as a notification unit. Thus, an occupant who mistakenly assumes that reception of electric power is allowed on a power available road 14 can be given a warning, for example, to the effect that the occupant has not yet paid for electricity or that the above-described IC card inserted in the in-vehicle equipment is invalid.

### [First Modification]

### [Configuration of First Modification]

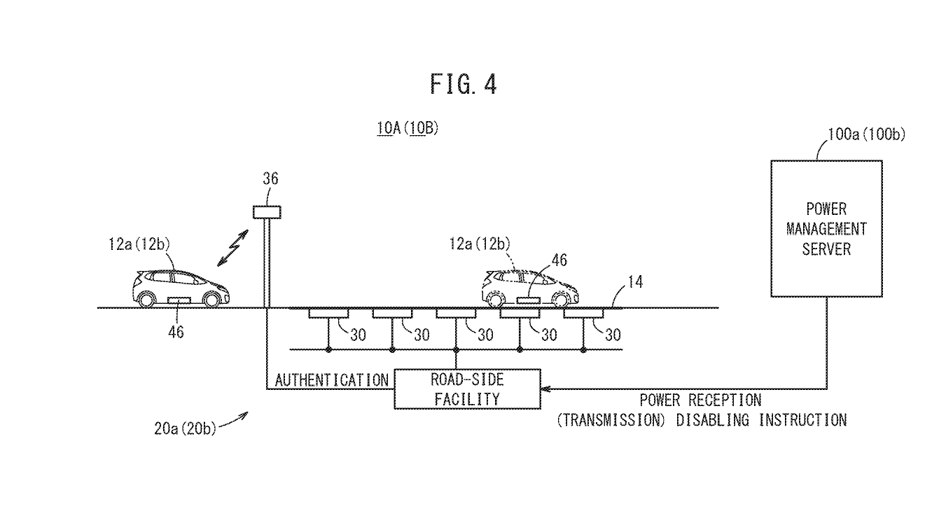

FIG. 4 is a diagram schematically showing the configuration of a power transmission system 10A for an electric vehicle 12a according to a first modification of the embodiment. FIG. 4 also serves as a diagram schematically showing the configuration of a power transmission system 10B according to a second modification as described later.

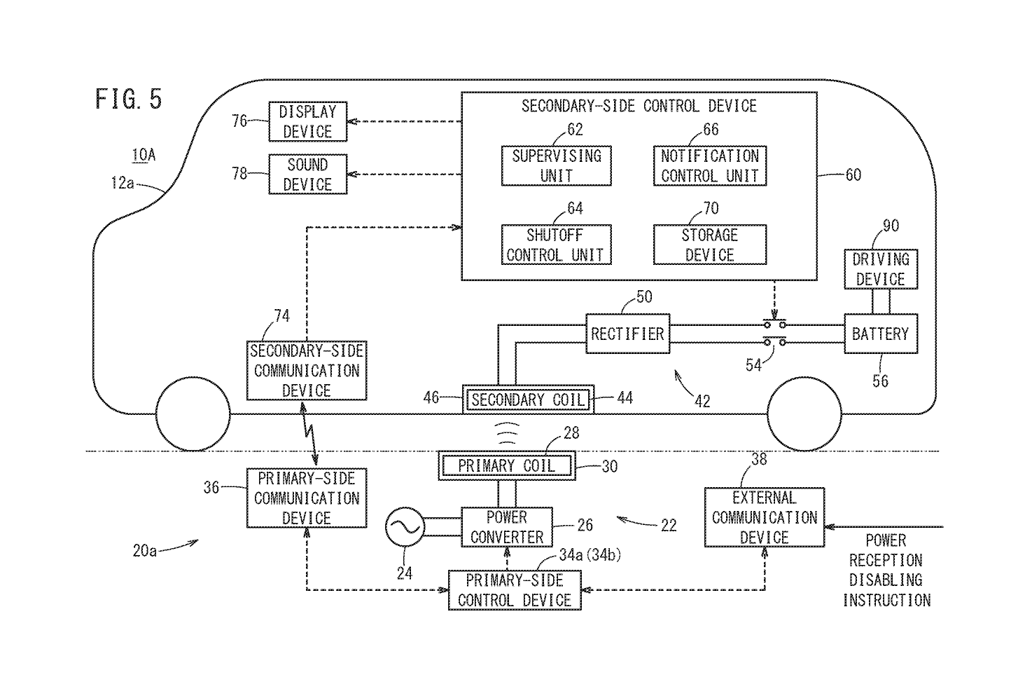

FIG. 5 is a diagram illustrating in more detail configurations of the electric vehicle 12a and a road-side facility 20a of the power transmission system 10A.

In FIGS. 4 and 5, components similar to those shown in FIGS. 1 and 2 are given the same reference numerals, and detailed descriptions thereof are omitted.

Compared to the electric vehicle 12 shown in FIG. 2, the electric vehicle 12a shown in FIG. 5 does not require the external communication device 80 but includes a secondary-side communication device 74, which is connected with the secondary-side control device 60 over a communication line.

Compared to the road-side facility 20 shown in FIG. 2, the road-side facility 20a shown in FIG. 5 includes an external communication device 38 which receives a “power reception disabling instruction” from a power management server 100a, and a primary-side communication device 36 which wirelessly communicates with the secondary-side communication device 74 of the electric vehicle 12a.

The primary-side communication device 36 is implemented in road-side equipment disposed on the road 14 (see FIG. 4). The primary-side communication device 36 may be provided on each primary pad 30, instead of in the road-side equipment.

The primary-side communication device 36 and the external communication device 38 are each connected with a primary-side control device 34a over communication lines.

### [Operation of First Modification]

The power management server 100a previously registers and stores therein electric vehicles 12a that are under management of users who have not yet paid the usage fee for the road-side facility 20a and electric vehicles 12a that are under management of users who have properly paid the usage fee, in cooperation with financial institutions such as banks.

The power management server 100a transmits, to the external communication device 38 of the road-side facility 20a, a “power reception disabling instruction” for an electric vehicle 12a among the registered electric vehicles 12a that has no right of use due to an unpaid usage fee or the like, together with a user ID and a password.

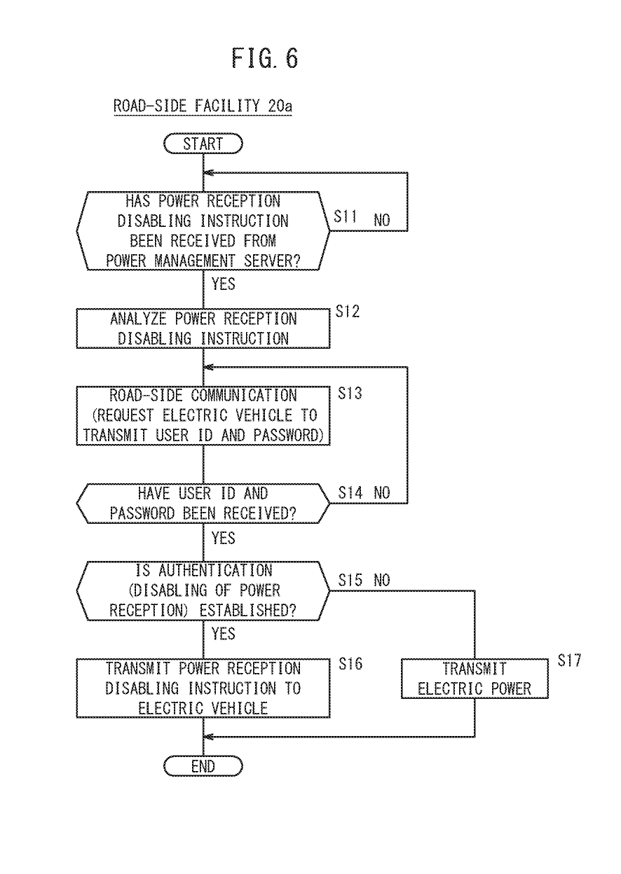

FIG. 6 shows a flowchart of a program executed by the primary-side control device 34a of the road-side facility 20a.

At step S11, the primary-side control device 34a determines whether a “power reception disabling instruction” has been received through the external communication device 38 or not. If a “power reception disabling instruction” has been received (step S11: YES), the primary-side control device 34a analyzes the received “power reception disabling instruction” at step S12.

Then, for execution of the instruction, road-side communication is performed at step S13 for an authentication process on the electric vehicle 12a approaching the primary-side communication device 36 as shown in FIG. 4. In this case, at step S13, the primary-side control device 34a requests the supervising unit 62 to transmit the user ID and the password, via the primary-side communication device 36 and the secondary-side communication device 74 of the electric vehicle 12a.

At step S14, the primary-side control device 34a determines whether the user ID and the password have been received or not. If the user ID and the password have not been received (step S14: NO), the flow returns to step S13.

When the user ID and the password have been received through the primary-side communication device 36 from the supervising unit 62 via the secondary-side communication device 74 (step S14: YES), the primary-side control device 34a performs an authentication process as to whether authentication is established or not (whether the electric vehicle is a reception-disabled vehicle or not) at step S15.

In the authentication process at step S15, the primary-side control device 34a verifies the password and user ID transmitted from the secondary-side communication device 74 of the electric vehicle 12a by comparing them with stored user ID and password that were transmitted from the power management server 100a.

If they agree with each other, the primary-side control device 34a transmits a “power reception disabling instruction” from the primary-side communication device 36 to the supervising unit 62 of the secondary-side control device 60 through the secondary-side communication device 74 at step S16.

The supervising unit 62 sends a shutoff command to the shutoff control unit 64 for execution of the instruction. Based on the shutoff command, the shutoff control unit 64 switches the contactor 54 from an ON state to an OFF state.

In this manner, as shown in FIG. 4, when the electric vehicle 12a travels from the left-hand side toward the road-side facility 20a in the drawing, since the contactor 54 has been switched to an OFF state based on authentication with the road-side facility 20a, the battery 56 is not charged even if the electric vehicle 12a travels on the road 14 in which the primary pad 30 is buried and electric power is being transmitted.

Upon analyzing the “power reception disabling instruction” from the power management server 100a, the supervising unit 62 sends a shutoff command to the shutoff control unit 64. Further, the supervising unit 62 controls the notification control unit 66 to cause the display device 76 to display an indication that “reception of electric power is not available because the user has not paid the fee” and also to cause the sound device 78 to inform the user of the fact by voice.

In the authentication described above, the primary-side communication device 36 may also be buried in the road 14 alongside of each primary pad 30, instead of being provided as road-side equipment as mentioned above.

If the authentication (disabling of power reception) is not established at step S15 (step S15: NO), the primary-side control device 34a transmits electric power via the power converter 26 and the primary coil 28 at step S17.

In this case, the transmission electric power from the primary coil 28 is received by the secondary coil 44, and the battery 56 is charged with the transmission electric power through the rectifier 50 and the contactor 54.

### [Second Modification]

### [Configuration of Second Modification]

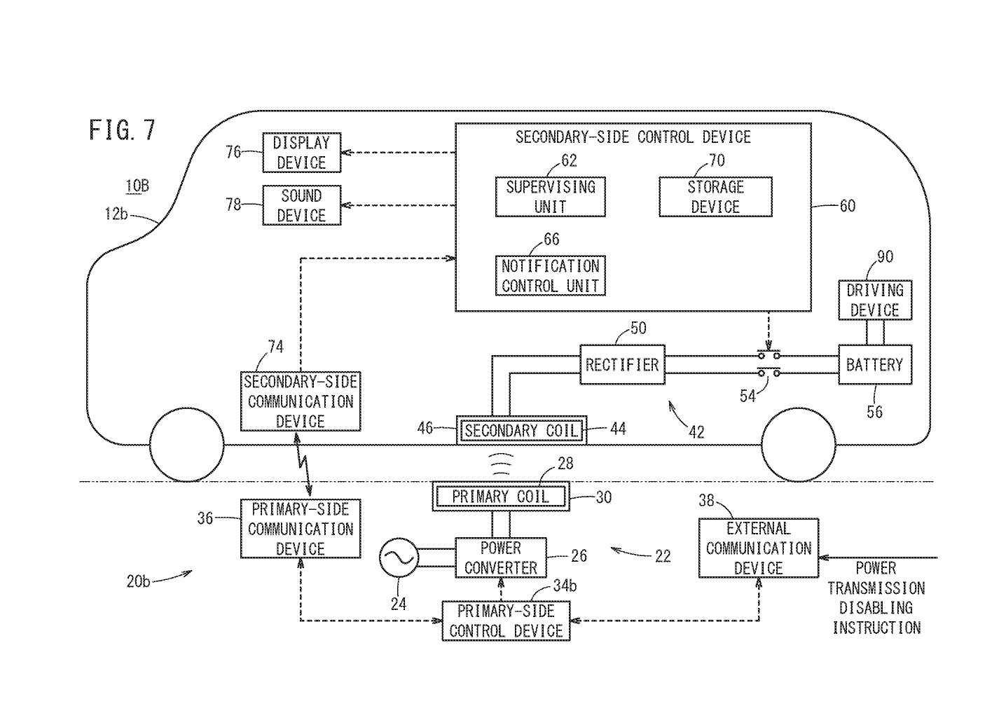

A second modification is described with reference to FIGS. 4 and 7.

In the second modification shown in FIG. 7, compared to the first modification shown in FIG. 5, the power transmission system 10A is replaced with a power transmission system 10B, the electric vehicle 12a is replaced with an electric vehicle 12b, the road-side facility 20a is replaced with a road-side facility 20b, and the primary-side control device 34a is replaced with a primary-side control device 34b.

The electric vehicle 12b does not include the shutoff control unit 64 of the electric vehicle 12a shown in FIG. 5.

### [Operation of Second Modification]

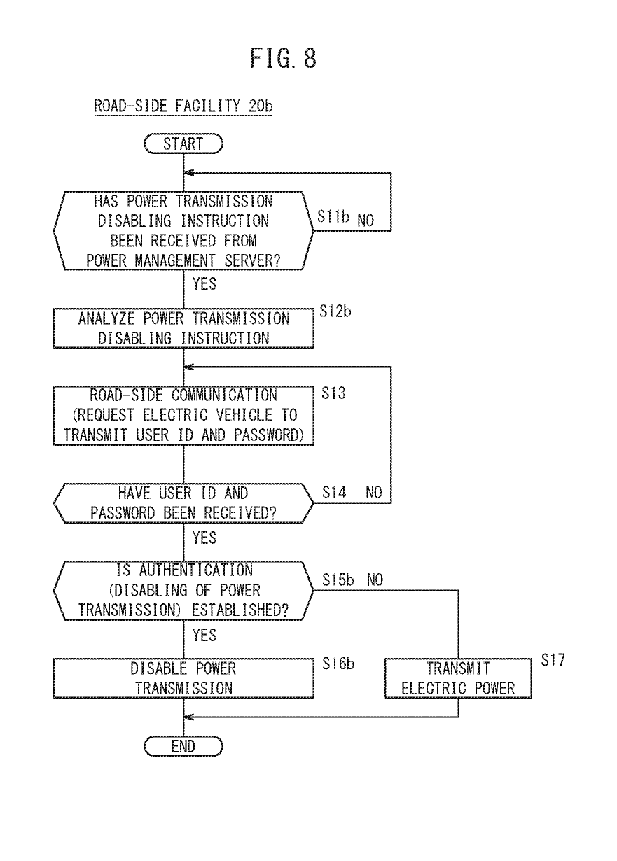

Referring to the flowchart of FIG. 8, the operation of the second modification is described.

FIG. 8 shows a flowchart of a program executed by the primary-side control device 34b of the road-side facility 20b.

Processing according to the flowchart of FIG. 8 is substantially the same as the processing from step S11 to step S17 in the flowchart of FIG. 6. Different steps are denoted by the same step number with addition of a suffix “b”, and detailed description is omitted.

At step S11b, the primary-side control device 34b determines whether a “power transmission disabling instruction” has been received from a power management server 100b through the external communication device 38 or not. If a “power transmission disabling instruction” has been received (step S11b: YES), the primary-side control device 34b analyzes the received “power transmission disabling instruction” at step S12b.

Then, for execution of the instruction, road-side communication is performed at step S13 for an authentication process on the electric vehicle 12b approaching the primary-side communication device 36 as shown in FIG. 4. In this case, at step S13, the primary-side control device 34b requests the supervising unit 62 to transmit the user ID and the password, via the primary-side communication device 36 and the secondary-side communication device 74 of the electric vehicle 12b.

At step S14, the primary-side control device 34b determines whether the user ID and the password have been received or not. If the user ID and the password have not been received (step S14: NO), the flow returns to step S13.

When the user ID and the password have been received at step S14 via the primary-side communication device 36 from the supervising unit 62 through the secondary-side communication device 74 (step S14: YES), the primary-side control device 34b performs an authentication process as to whether authentication is established or not (whether the electric vehicle is a power transmission-disabled vehicle or not) at step S15b.

In the authentication process at step S15b, the primary-side control device 34b verifies the user ID and password transmitted from the secondary-side communication device 74 of the electric vehicle 12b by comparing them with stored user ID and password that were transmitted from the power management server 100b.

If they agree with each other, the primary-side control device 34b stops a power converting operation of the power converter 26 at step S16b. By stopping the power converting operation of the power converter 26, electric power is no longer transmitted from the primary coil 28. That is, transmission of electric power from the primary coil 28 is prohibited or disabled.

As shown in FIG. 4, in a case that the electric vehicle 12b travels from the left-hand side toward the road-side facility 20b in the drawing, even if the electric vehicle 12b travels on the road 14 in which the primary pad 30 is buried, no electric power is transmitted from the primary coil 28. Therefore, the battery 56 is not charged.

At step S16b, the primary-side communication device 36 sends an indication to the effect that “transmission of electric power has been disabled” to the supervising unit 62 of the secondary-side control device 60 through the secondary-side communication device 74.

The supervising unit 62 controls the notification control unit 66 to cause the display device 76 to display an indication that “reception of electric power is not available because the user has not paid the fee” and also to cause the sound device 78 to inform the user of the fact by voice.

In the authentication described above, the primary-side communication device 36 may also be buried in the road 14 alongside of each primary pad 30, instead of being provided as road-side equipment as mentioned above.

In this case also, if the authentication (disabling of power transmission) is not established at step S15b (step S15b: NO), the primary-side control device 34b transmits electric power via the power converter 26 and the primary coil 28 at step S17.

Then, the transmission electric power from the primary coil 28 is received by the secondary coil 44, and the battery 56 is charged with the transmission electric power through the rectifier 50 and the contactor 54.

### [Summation of Second Modification]

As described with reference to FIGS. 4, 7, and 8, the road-side facility 20b according to the above second modification automatically transmits electric power from the side of the road 14 to the electric vehicle 12b traveling on the road 14, under control of the power management server 100b as the power management entity, and includes the primary-side communication device 36 as the road-side communication device.

When a power transmission disabling instruction to disable transmission of electric power to a particular electric vehicle 12b (identified by a user ID and a password) is sent from the power management server 100b (step S11b), the road-side facility 20b communicates with an electric vehicle 12b via the primary-side communication device 36 and the secondary-side communication device 74. If that electric vehicle 12b is identified as the particular electric vehicle 12b (step S15b: YES), the road-side facility 20b stops (disables) the transmission of electric power to that electric vehicle 12b from the side of the road 14 (step S16b).

In this manner, the road-side facility 20b according to the second modification stops the transmission of electric power to the electric vehicle 12b from the side of the road 14 upon receiving a power transmission disabling instruction from the power management server 100b. Thus, occurrence of wasted electric power at the road-side facility 20b can be completely eliminated.

### Third Modification

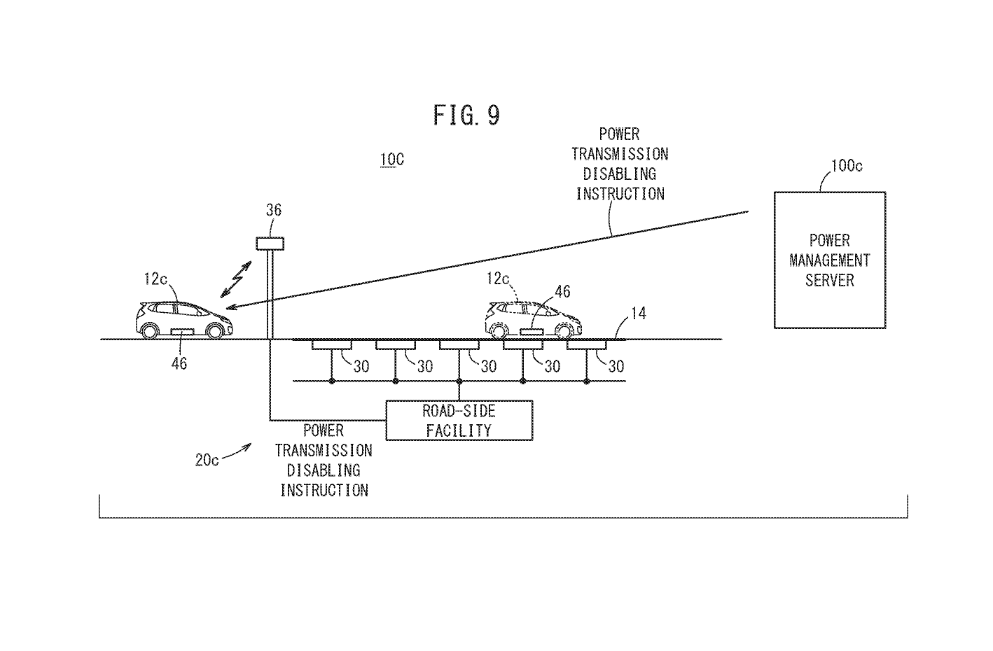

Unlike in the second modification, a configuration of a power transmission system 10C shown in FIG. 9 may be adopted, in which a “power transmission disabling instruction” transmitted from a power management server 100c is sent to a road-side facility 20c by way of an electric vehicle 12c, and the road-side facility 20c stops the transmission of electric power.

As will be appreciated, the present invention is not limited to the above embodiment but it may be configured in different ways based on the description of the specification, such as removing a prohibition of charging within a disaster-affected area, for example.

What is claimed is:

1. An electric vehicle configured to receive, during traveling, electric power transmitted from a road-side facility provided on a side of a road, the road-side facility being managed by a power management entity, the electric vehicle comprising:
a receiver configured to receive an instruction from the power management entity;
a shutoff unit configured to shut off reception of the electric power transmitted from the road-side facility; and
a controller connected to the receiver and the shutoff unit,
wherein the controller controls the shutoff unit when a power reception disabling instruction for the electric vehicle is received from the power management entity through the receiver.

2. The electric vehicle according to claim 1, wherein the shutoff unit is a contactor.

3. The electric vehicle according to claim 1, wherein the receiver receives the power reception disabling instruction from the power management entity through a road-side communication device of the road-side facility.

4. The electric vehicle according to claim 1, further comprising a notification unit,
wherein when reception of the electric power by the electric vehicle is shut off, the controller notifies an occupant of the electric vehicle of the shutoff through the notification unit.

5. A power transmission system configured to transmit electric power to an electric vehicle from a road-side facility provided on a side of a road, the road-side facility being managed by a power management entity, the power transmission system comprising a road-side communication device,
wherein, when a power transmission disabling instruction to disable transmission of electric power to a particular electric vehicle is sent from the power management entity to the road-side facility, the road-side facility communicates with the electric vehicle via the road-side communication device, and if the electric vehicle is identified as the particular electric vehicle, the road-side facility stops transmission of electric power to the electric vehicle.

6. A power transmission system configured to transmit electric power to an electric vehicle from a road-side facility provided on a side of a road, the road-side facility being managed by a power management entity, the power transmission system comprising a road-side communication device,
wherein, when a power transmission disabling instruction to disable transmission of electric power to a particular electric vehicle is sent from the power management entity to the particular electric vehicle, the particular electric vehicle transmits the power transmission disabling instruction to the road-side facility via the road-side communication device, and upon receiving the power transmission disabling instruction, the road-side facility stops transmission of electric power to the particular electric vehicle from the road-side facility.
